(19) United States
(12) Patent Application Publication
(10) Pub. No.: US 2024/0428079 A1
(43) Pub. Date: Dec. 26, 2024

(54) SYSTEMS AND METHODS FOR TRAINING A LANGUAGE MODEL FOR CODE GENERATION

(71) Applicant: Salesforce, Inc., San Francisco, CA (US)

(72) Inventors: Hailin Chen, Singapore (SG); Amrita Saha, Singapore (SG); Chu Hong (Steven) Hoi, Singapore (SG); Shafiq Rayhan Joty, San Jose, CA (US)

(21) Appl. No.: 18/499,101

(22) Filed: Oct. 31, 2023

Related U.S. Application Data
(60) Provisional application No. 63/510,071, filed on Jun. 23, 2023.

(51) Int. Cl. G06N 3/09

(52) U.S. Cl. CPC G06N 3/09

(57) ABSTRACT

Embodiments described herein provide a system for training a neural network model using a teacher-student framework. The system includes a communication interface configured to communicate with a teacher model; a memory storing a student model and a plurality of processor-executable instructions; and a processor executing the processor-executable instructions to perform operations. The operations include: generating, by the student model, a first task output in response to a task input; obtaining, from an evaluation environment, a feedback relating to an accuracy of the first task output; obtaining a refinement output generated by the teacher model based on an input of the first task output and the feedback; and training the student model based on a training input of the first task output and the feedback and a training label of the refinement output.

### CROSS REFERENCE(S)

The instant application is a nonprovisional of and claim priority under 35 U.S.C. 119 to U.S. provisional application No. 63/510,071, filed Jun. 23, 2023, which is hereby expressly incorporated by reference herein in its entirety.

### TECHNICAL FIELD

The embodiments relate generally to machine learning systems for code generation, and more specifically to systems and methods for training a language model to improve code generation.

### BACKGROUND

Large Language Models (LLMs) such as GPT 4.0, and/or the like have been used in various generative applications, such as improving writing proficiency, code generation, and/or the like. Sometimes, due to resource constraints such as availability of services, cost, ethics, safety, and potential data privacy implications, a neural network model of a smaller size and/or open source may be deployed in specific use cases. However, training of the smaller neural network model can be challenging because smaller neural networks are often built and/or pretrained for a specific task, and training data to adapt the smaller neural network to a specific domain and/or task may not be available.

### BRIEF DESCRIPTION OF THE DRAWINGS

FIG. 1 illustrates an existing teacher-student framework for training a student model.

FIG. 2 illustrates an exemplary personalized refinement framework for training a student model, according to some embodiments of the present disclosure.

FIG. 3A illustrates coding segments of a student model's output based on a task input, an error message to the student model's output, a teacher model's refinement output to the student model's output, according to some embodiments of the present disclosure.

FIG. 3B illustrates a coding segment of a teacher model's output based on a task input, according to some embodiments of the present disclosure.

FIG. 4 is a simplified diagram illustrating a computing device implementing the personalized refinement framework described in FIGS. 2, 3A, and 3B, according to some embodiments.

FIG. 5 is a simplified diagram illustrating a neural network structure, according to some embodiments.

FIG. 6 is a simplified block diagram of a networked system suitable for implementing the personalized refinement framework described in FIGS. 2, 3A, and 3B and other embodiments described herein.

FIG. 7A illustrates an example algorithm performed by a personalized refinement framework, according to some embodiments.

FIG. 7B is an example logic flow diagram illustrating a method of personalized refinement based on the algorithm shown in FIG. 7A, according to some embodiments.

FIGS. 8-11 provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters.

### Overview

LLMs have been used in various generative, such as improving writing proficiency, code generation, and/or the like. Sometimes, due to resource constraints such as availability of services, cost, ethics, safety, and potential data privacy implications, a neural network model of smaller size and/or open source may be deployed in specific use cases. The smaller neural network model is often trained using a teacher-model framework with a larger and more general LLM, e.g., a teacher model. The smaller student model can be trained using teacher outputs as ground-truths. As the teacher (the LLM) and student (the smaller neural network model) may have different structures, blindly using teacher outputs as training signals largely under-utilizes the student model's learning ability and capacity. The traditional teacher-student training framework can thus cause low training efficiency in the student model.

In view of the need to improve learning efficiency of the student model, embodiments described herein provide a training framework that trains and/or finetunes a neural network such as a language model (student) to refine its output according to refinement instructions from another pretrained LLM (teacher). Specifically, the student may first generate a student output in response to an input, e.g., a code sample in response to a natural language task description. The student output may then be tested in an environment and feedback on its accuracy may be collected, e.g., error message by executing a generated code sample. The student output, feedback may then be input to the teacher which in turn generates a refinement output, e.g., a code sample that corrects the student generated code based on the feedback. The refinement output may then be used together with the original task input, student output and feedback, as a training pair to refine the student model.

In this way, training data to refine the student model is highly personalized to reflect the student model's learning efficiency and capability, e.g., by using training samples built on the student model's own output, together with execution feedback. As training efficiency is improved for the student model, the training framework results in an improved neural network (student model) for automatically generating programming code. Neural network technology in code generation is thus improved.

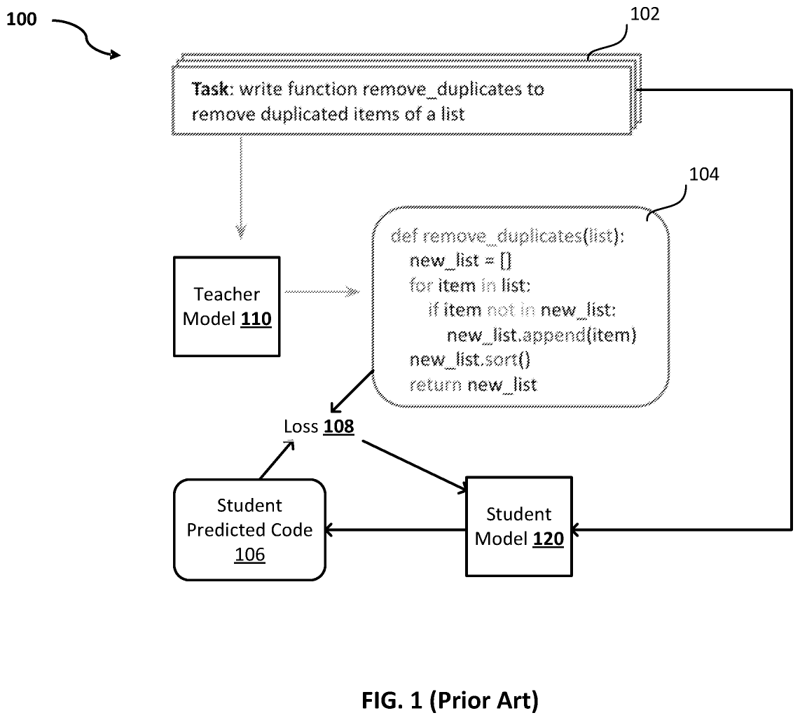

FIG. 1 is a simplified diagram illustrating an existing teacher-student training framework 100, according to embodiments described herein. The framework 100 comprises a teacher model 110 (such as an LLM) and a student model 120 (such as a language model of a smaller size). The student model 120 may be trained using teacher output as ground truth in the training framework 100, e.g., when training data is not available to student model 120 for data privacy concerns, service constraints, and/or the like.

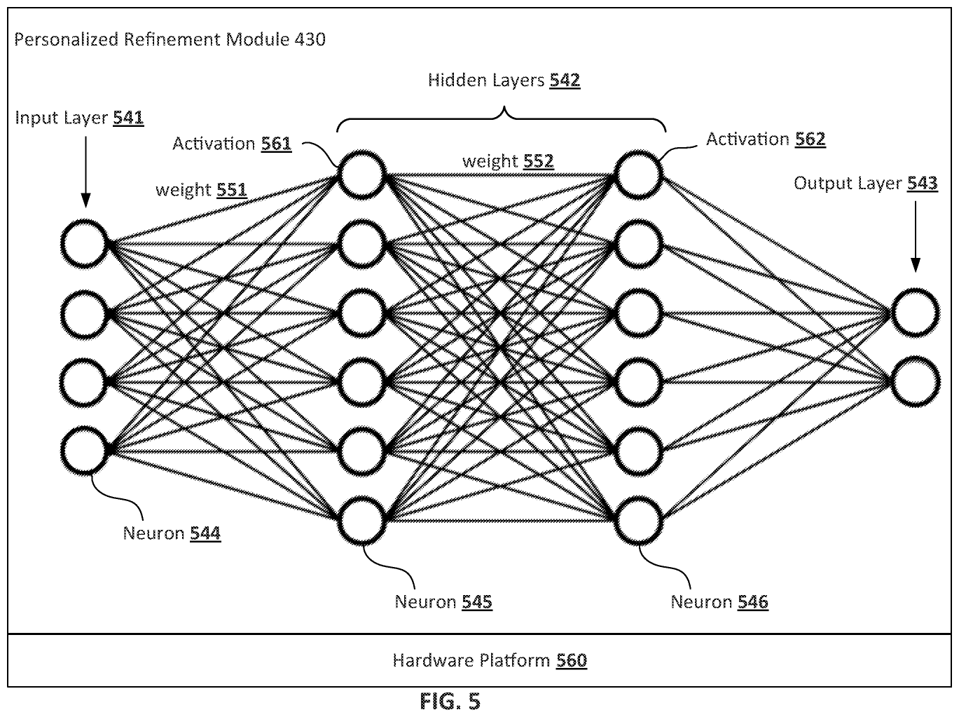

In one embodiment, a task input 102, including the description of a task such as a natural language description to generate a code segment that performs a certain function, is fed to a teacher model 110 and a student model 120. Teacher model 110 may generate a task output 104, which includes a code segment to solve the task described in task input 102. Student model 120 may also generate student predicted code, e.g., a task output, attempting the solve the task described in task input 102. Student model 120 may be trained based on a loss objective 108 using task output 104, i.e., the teacher's output, as the ground-truth. Additional details of training a neural network such as a student model 120 via backpropagation are provided in FIG. 5.

As described above, the training in the existing teacher-student framework 100 lacks the consideration of the student model's learning ability and capacity, and forces the student model to learn from the teacher model's direct output. Therefore, when the teacher model 110 and student model 120 are drastically different in structure and generative capacity, the student model 120 may suffer potential low learning efficiency using the framework 100.

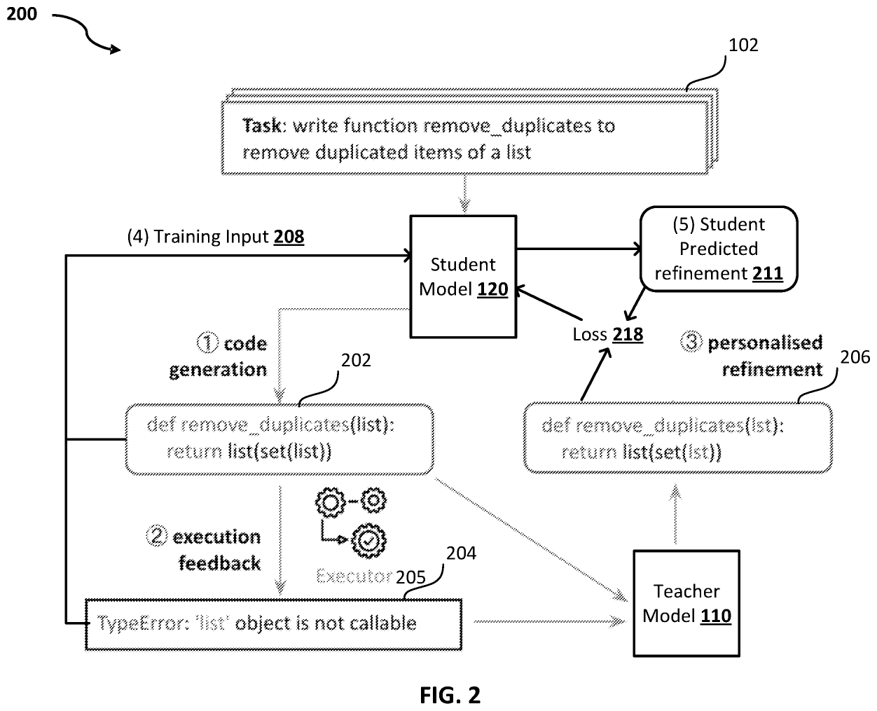

FIG. 2 is a simplified diagram illustrating a personalized teacher-student training framework 200 for training of a student model, personalized refinement framework according to some embodiments. The framework 200 includes a teacher model 110, a student model 120, and an executor 205 (such as an execution environment for a code program) that is operatively connected to teacher model 110 and student model 120. The framework 200 may be used to generate training data that is personalized to the learning capability of the student model 120 thereby training the student model 120 in an efficient manner. In some embodiments, teacher model 110 is hosted in an external server and is accessible by student model 120 via an application programming interface (API). In some embodiments, teacher model 110 is a pretrained language model.

In one embodiment, a task input 102, including the description of a task such as a natural language description to generate a code segment that performs a certain function, is fed to the student model 120, which in turn generates a task output 202. Task output 202 may include a code segment, e.g., a programming language segment, aiming to execute the task described in task input 102. Task output 202, e.g., the code segment, may be executed by an executor using a unit test case in an evaluation environment to generate execution feedback 204 indicating whether the code segment 202 is successful and/or accurate to the desired task described in task description 102. For example, when the code segment 202 does not successfully execute the task, the feedback 204 may include an error message that indicates the error in the code segment. In some embodiments, feedback 204 is generated upon a user review.

In one embodiment, code segment 202 (and/or task outputs in other forms) may be evaluated in a variety of different ways. For example, a human evaluator may provide feedback 204 by reviewing task output 202. For another example, task output 202 may be compared with a reference output to provide feedback 204.

In one embodiment, the teacher model 110 may receive an input concatenating receive the task output 202 and feedback 204. Conditioned on the input, teacher model 110 may generate a refinement output 206 adapted to task output 202 based on the feedback 204. For example, refinement output 206 may comprise a code segment that corrects the code segment 202 based on feedback 204, and thus may “better” execute the task in the original task input 102. In this way, refinement output 206 includes refinement data/code that is personalized for the student model 120 to correct the error contained in the task output 202 generated by the student model 120.

In one embodiment, a training input 208 for the student model 120 may be generated based on the task input 102, task output 202, and feedback 204 by populating a refinement prompt template T_{refine}. For example, the refinement template may be taken a form similar to:

Rectify the below code for the given task based on the errors:

Task:
<<TASK>>
<<Code>>
Error:
<<Error>>
<<Task>>
<<Header>>

Student model 120 may output a predicted refinement 211 conditioned on training input 208. Predicted refinement 211 may include a code segment that refines task output 202 to solve the task described in task input 102. Teacher model 120's refinement output 206 may be used as ground-truth such that predicted refinement 211 is compared to refinement output 206 to compute a loss objective 218. The student model 120 may then be updated using the loss 218. Additional details of training a neural network such as a student model 120 via backpropagation are provided in FIG. 5.

In some embodiments, refinement output 206 may be executed and tested before being used as training data. For example, if refinement output 206 fails to pass the execution test, refinement output 206 may not be used in the training sample.

In some embodiments, if task output 202 passes the execution/unit test case, e.g., with no error message, task input 102 may be filtered out so that task output 202 is not fed to teacher model 110 for refinement output, and is not retained as training data.

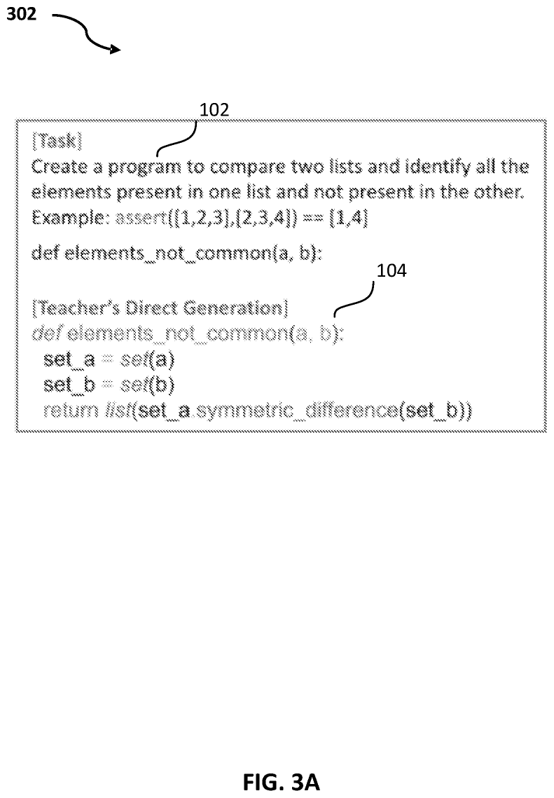

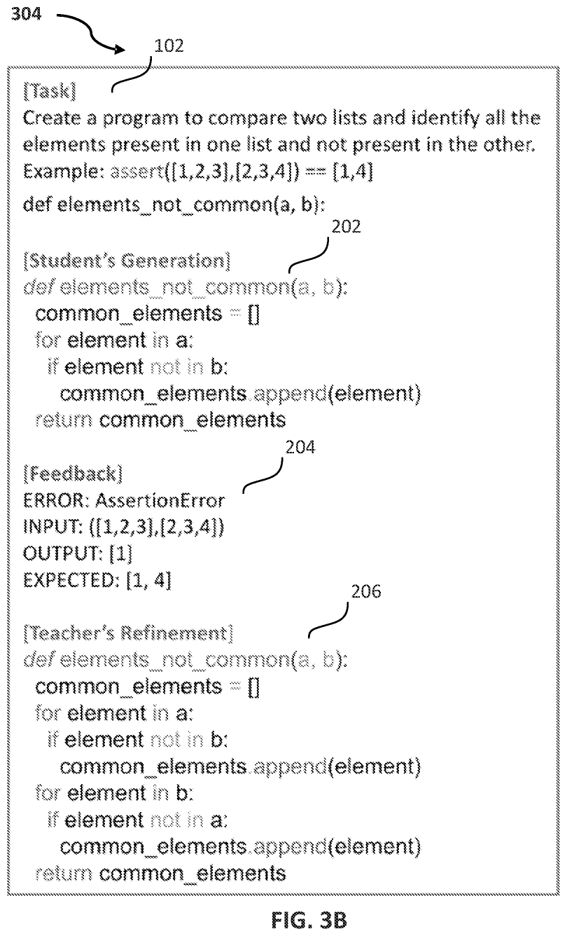

FIG. 3A is a simplified diagram illustrating an example of a training sample used in teacher-student training framework 100 in FIG. 1, according to embodiments described herein. The training sample 302 includes a task description 102 as a training input, and the teacher's direct generation 104 as the annotated ground-truth label for the training input.

FIG. 3B is a simplified diagram illustrating an example of a training sample used in teacher-student training framework 200 in FIG. 2, according to embodiments described herein. The training sample 204 includes a training input of a task input 102, the student model 120's task output 202 conditioned on task input 102, feedback 204 as a training input, and teacher model 110's refinement output 206 as a ground-truth label for the training input.

In one embodiment, training data samples as shown in one or both of FIGS. 3A-3B may be used to train the student model 120. For example, a training dataset combining both datasets D_{code} of training samples 302 and D_{refine} of training samples 304 may be generated and stored, referred to as PERsD-combined. A training dataset combining only D_{refine} of training samples 304 may be generated and stored, referred to as PERsD-refine. A training dataset of a training sample using the task input 102 as a training input and refinement output 206 as a ground-truth label for the training input may be generated and stored, referred to as PERsD. The three sets of training data may be independently, alternately, concurrently, sequentially, and/or in other manner used to train student model 120.

It is to be noted that embodiments described in FIGS. 1-3B relate to the task of code generation using language models for illustrative purpose only. For example, teacher model 110 and student model 120 may be a variety of different types of neural network models that are pretrained, trained and/or finetuned to perform a variety of tasks such as natural language processing (NLP), image recognition, audio processing, with various types of input data of different modality such as natural language, image, audio, and/or the like.

### Computer and Network Environment

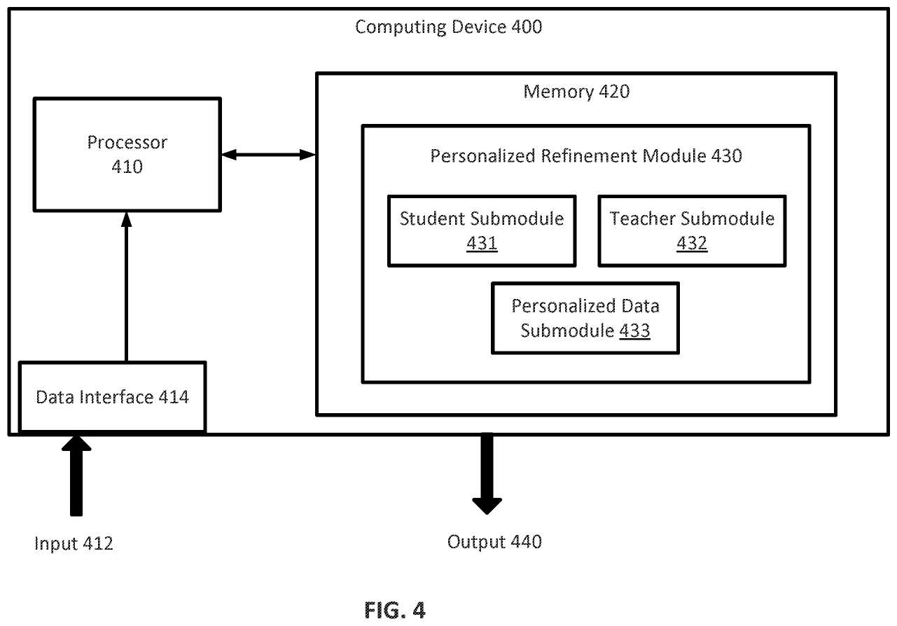

FIG. 4 is a simplified diagram illustrating a computing device implementing the personalized refinement framework 200 described in FIGS. 2, 3A, and 3B, according to one embodiment described herein. As shown in FIG. 4, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for personalized refinement module 430 that may be used to implement and/or emulate the systems and models, and/or to implement any of the methods described further herein. Personalized refinement module 430 may receive input 440 such as an input training data (e.g., task input, task refinement input) via the data interface 415 and generate an output 450 which may be a predicted refinement.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as task input or task refinement input, from a user via the user interface.

In some embodiments, the personalized refinement module 430 is configured to generate training data for the student model and trains/finetunes the student model using the training data. The personalized refinement module 430 may further include a student submodule 431 (e.g., similar to student model 120 in FIG. 2), a teacher submodule 432 (e.g., similar to teacher model 110 in FIG. 2), and a personalized data submodule 433. Student submodule 431 may be configured to generate part of the training data (e.g., PERsD-combined, PERsD-refine, and PERsD) conditioned in the task input, and train on one or more sets of training data. Teacher submodule 432 may be configured to generate part of the training data conditioned on the student submodule 431's task output and feedback to the task output. Personalized data submodule 433 may be configured to generate and store the training data (e.g., PERsD-combined, PERsD-refine, and PERsD) based on the input and output of student submodule 431 and teacher submodule 432.

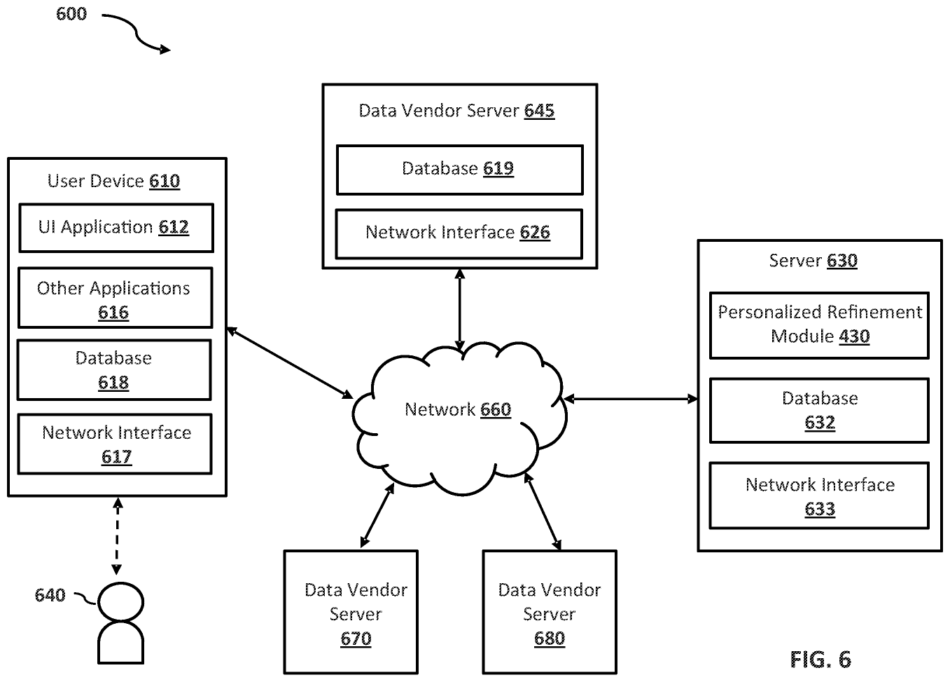

It is noted that the student submodule 431 and teacher submodule 432 may be located on different computing devices, servers, and/or the like. For example, teacher submodule 432 may be located on a remote server external to computing device 400, and student submodule 431 may be communicatively coupled to teacher submodule 432 via data interface 414 and a communication network (e.g., 660 in FIG. 6).

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 5 is a simplified diagram illustrating the neural network structure implementing the personalized refinement module 430 described in FIG. 4, according to some embodiments. In some embodiments, the personalized refinement module 430 and/or one or more of its submodules 431-433 may be implemented at least partially via an artificial neural network structure shown in FIG. 5. The neural network comprises a computing system that is built on a collection of connected units or nodes, referred to as neurons (e.g., 544, 545, 546). Neurons are often connected by edges, and an adjustable weight (e.g., 551, 552) is often associated with the edge. The neurons are often aggregated into layers such that different layers may perform different transformations on the respective input and output transformed input data onto the next layer.

For example, the neural network architecture may comprise an input layer 541, one or more hidden layers 542 and an output layer 543. Each layer may comprise a plurality of neurons, and neurons between layers are interconnected according to a specific topology of the neural network topology. The input layer 541 receives the input data (e.g., 440 in FIG. 4), such as task input, and/or task refinement input. The number of nodes (neurons) in the input layer 541 may be determined by the dimensionality of the input data (e.g., the length of a vector of task input and/or task refinement input). Each node in the input layer represents a feature or attribute of the input.

The hidden layers 542 are intermediate layers between the input and output layers of a neural network. It is noted that two hidden layers 542 are shown in FIG. 5 for illustrative purpose only, and any number of hidden layers may be utilized in a neural network structure. Hidden layers 542 may extract and transform the input data through a series of weighted computations and activation functions.

For example, as discussed in FIG. 4, the personalized refinement module 430 receives an input 440 of task input, task refinement input and transforms the input into an output 450 of predicted refinement. To perform the transformation, each neuron receives input signals, performs a weighted sum of the inputs according to weights assigned to each connection (e.g., 551, 552), and then applies an activation function (e.g., 561, 562, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 541 is transformed into rather different values indicative data characteristics corresponding to a task that the neural network structure has been designed to perform.

The output layer 543 is the final layer of the neural network structure. It produces the network's output or prediction based on the computations performed in the preceding layers (e.g., 541, 542). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the personalized refinement module 430 and/or one or more of its submodules 431-433 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be CodeGen-mono-6B, CodeGen-mono-16B, StarCoder, and/or the like.

In one embodiment, the personalized refinement module 430 and its submodules 431-433 may be implemented by hardware, software and/or a combination thereof. For example, the personalized refinement module 430 and its submodules 431-433 may comprise a specific neural network structure implemented and run on various hardware platforms 560, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

In one embodiment, the neural network based personalized refinement module 430 and one or more of its submodules 431-433 may be trained by iteratively updating the underlying parameters (e.g., weights 551, 552, etc., bias parameters and/or coefficients in the activation functions 561, 562 associated with neurons) of the neural network based on the loss objective 218. For example, during forward propagation, the training data such as task input and/or task refinement input are fed into the neural network. The data flows through the network's layers 541, 542, with each layer performing computations based on its weights, biases, and activation functions until the output layer 543 produces the network's output 450. In some embodiments, output layer 543 produces an intermediate output on which the network's output 450 is based.

The output generated by the output layer 543 is compared to the expected output (e.g., a “ground-truth” such as the corresponding label of the teacher model's refinement output) from the training data, to compute a loss function that measures the discrepancy between the predicted output and the expected output. For example, the loss function may be a cross entropy, MMSE, or other suitable loss functions. Given the loss, the negative gradient of the loss function is computed with respect to each weight of each layer individually. Such negative gradient is computed one layer at a time, iteratively backward from the last layer 543 to the input layer 541 of the neural network. These gradients quantify the sensitivity of the network's output to changes in the parameters. The chain rule of calculus is applied to efficiently calculate these gradients by propagating the gradients backward from the output layer 543 to the input layer 541.

Parameters of the neural network are updated backwardly from the last layer to the input layer (backpropagating) based on the computed negative gradient using an optimization algorithm to minimize the loss. The backpropagation from the last layer 543 to the input layer 541 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as generate code based on an unknown task instruction.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

Therefore, the training process transforms the neural network into an “updated” trained neural network with updated parameters such as weights, activation functions, and biases. The trained neural network thus improves neural network technology in code generation.

FIG. 6 is a simplified block diagram of a networked system 600 suitable for implementing the personalized refinement framework described in FIGS. 2, 3A, and 3B and other embodiments described herein. In one embodiment, system 600 includes the user device 610 which may be operated by user 640, data vendor servers 645, 670 and 680, server 630, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4, operating an OS such as a MICROSOFT® OS, a UNIX® OS, a LINUX® OS, or other suitable device and/or server-based OS. It can be appreciated that the devices and/or servers illustrated in FIG. 6 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 610, data vendor servers 645, 670 and 680, and the server 630 may communicate with each other over a network 660. User device 610 may be utilized by a user 640 (e.g., a driver, a system admin, etc.) to access the various features available for user device 610, which may include processes and/or applications associated with the server 630 to receive an output data anomaly report.

User device 610, data vendor server 645, and the server 630 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 600, and/or accessible over network 660.

User device 610 may be implemented as a communication device that may utilize appropriate hardware and software configured for wired and/or wireless communication with data vendor server 645 and/or the server 630. For example, in one embodiment, user device 610 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 610 of FIG. 6 contains a user interface (UI) application 612, and/or other applications 616, which may correspond to executable processes, procedures, and/or applications with associated hardware. For example, the user device 610 may receive a message indicating a task instruction (e.g., used as a task input) from the server 630 and display the message via the UI application 612. In other embodiments, user device 610 may include additional or different modules having specialized hardware and/or software as required.

In various embodiments, user device 610 includes other applications 616 as may be desired in particular embodiments to provide features to user device 610. For example, other applications 616 may include security applications for implementing client-side security features, programmatic client applications for interfacing with appropriate application programming interfaces (APIs) over network 660, or other types of applications. Other applications 616 may also include communication applications, such as email, texting, voice, social networking, and IM applications that allow a user to send and receive emails, calls, texts, and other notifications through network 660. For example, the other application 616 may be an email or instant messaging application that receives a prediction result message from the server 630. Other applications 616 may include device interfaces and other display modules that may receive input and/or output information. For example, other applications 616 may contain software programs for asset management, executable by a processor, including a graphical user interface (GUI) configured to provide an interface to the user 640 to view the user's task output or task refinement.

User device 610 may further include database 618 stored in a transitory and/or non-transitory memory of user device 610, which may store various applications and data and be utilized during execution of various modules of user device 610. Database 618 may store user profile relating to the user 640, predictions previously viewed or saved by the user 640, historical data received from the server 630, and/or the like. In some embodiments, database 618 may be local to user device 610. However, in other embodiments, database 618 may be external to user device 610 and accessible by user device 610, including cloud storage systems and/or databases that are accessible over network 660.

User device 610 includes at least one network interface component 617 adapted to communicate with data vendor server 645 and/or the server 630. In various embodiments, network interface component 617 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 645 may correspond to a server that hosts database 619 to provide training datasets including PERsD-combined, PERsD-refine, and/or PERsD to the server 630. The database 619 may be implemented by one or more relational database, distributed databases, cloud databases, and/or the like.

The data vendor server 645 includes at least one network interface component 626 adapted to communicate with user device 610 and/or the server 630. In various embodiments, network interface component 626 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 645 may send asset information from the database 619, via the network interface 626, to the server 630.

The server 630 may be housed with the personalized refinement module 430 and its submodules described in FIG. 4. In some implementations, personalized refinement module 430 may receive data from database 619 at the data vendor server 645 via the network 660 to generate task output and/or task refinement. The generated task output and/or task refinement may also be sent to the user device 610 for review by the user 640 via the network 660.

The database 632 may be stored in a transitory and/or non-transitory memory of the server 630. In one implementation, the database 632 may store data obtained from the data vendor server 645. In one implementation, the database 632 may store parameters of the personalized refinement module 430. In one implementation, the database 632 may store previously generated task input, task output, and/or task refinement, and the corresponding input feature vectors.

In some embodiments, database 632 may be local to the server 630. However, in other embodiments, database 632 may be external to the server 630 and accessible by the server 630, including cloud storage systems and/or databases that are accessible over network 660.

The server 630 includes at least one network interface component 633 adapted to communicate with user device 610 and/or data vendor servers 645, 670 or 680 over network 660. In various embodiments, network interface component 633 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 660 may be implemented as a single network or a combination of multiple networks. For example, in various embodiments, network 660 may include the Internet or one or more intranets, landline networks, wireless networks, and/or other appropriate types of networks. Thus, network 660 may correspond to small scale communication networks, such as a private or local area network, or a larger scale network, such as a wide area network or the Internet, accessible by the various components of system 600.

### Example Work Flows

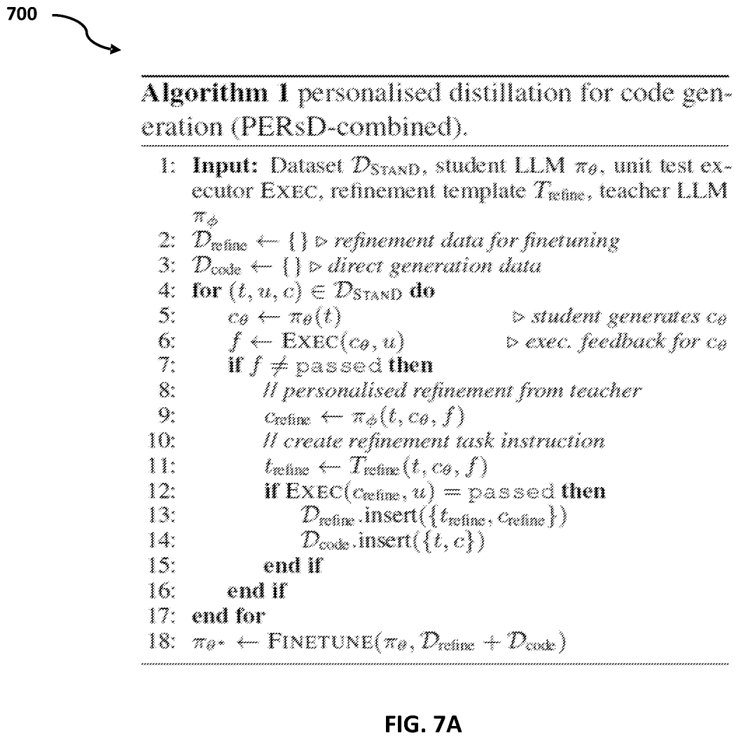

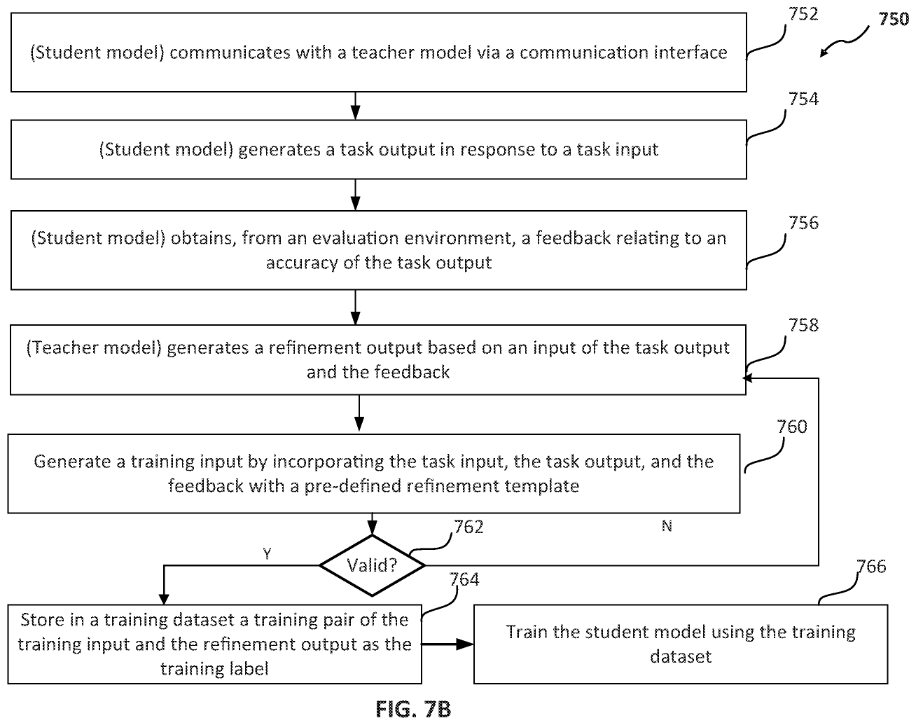

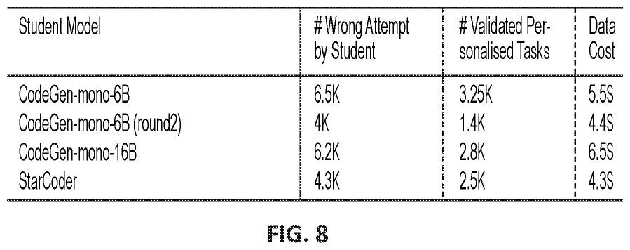

FIG. 7A provides an example pseudo-code segment illustrating an example algorithm 700 for a method of personalized refinement based on the framework shown in FIGS. 2, 3A, and 3B. FIG. 7B provides an example logic flow diagram illustrating a method 750 of personalized refinement according to the algorithm 700 in FIG. 7A, according to some embodiments described herein. One or more of the processes of method 750 may be implemented, at least in part, in the form of executable code stored on non-transitory, tangible, machine-readable media that when run by one or more processors may cause the one or more processors to perform one or more of the processes. In some embodiments, method 750 corresponds to an example operation of the personalized refinement module 430 (e.g., FIG. 4).

As illustrated, the method 750 includes a number of enumerated steps, but aspects of the method 750 may include additional steps before, after, and in between the enumerated steps. In some aspects, one or more of the enumerated steps may be omitted or performed in a different order.

As shown in FIG. 7A, line 1-3 shows algorithm 700 may be executed based on dataset D_{STAND}={(t, u, c)}, a student model (e.g., LLM) π_{θ}, a teacher model (LLM) π_{Φ}, a unit test execution feedback EXEC, a refinement template T_{refine}. D_{STAND} represents a set of code generation tasks, in which each task includes a task instruction t, a suite of unit tests u, and a correction solution code c. The unit test execution feedback EXEC is obtained by executing a student's task output c_{Φ} against unit test cases u, e.g., f←EXEC(c_{Φ}, u). Training datasets D_{refine} and D_{code} may be initialized to be updated. FIGS. 7A and 7B illustrate the generation of training dataset PERsD-combined, and using PERsD-combined for the training/finetune of the student model π_{θ}.

At step 752, a student model communicates with a teacher model via a communication interface. In some embodiments, the student model π_{θ} (e.g., similar to student model 120) may communicate with a teacher model π_{Φ} (e.g., similar to teacher model 110) via a communication interface (e.g., similar to network interface 633).

At step 754, the student model generates a task output in response to a task input. As shown in line 4-5 of algorithm 700, the student model xe may generate a task output ce in response to a task input t.

At step 756, the student model obtains, from an evaluation environment, a feedback relating to an accuracy of the task output. As shown in line 6 of algorithm 700, the student model π_{θ} may obtain a unit test (u) execution feedback f←EXEC(c_{θ}, u) relating to the accuracy of task output c_{θ}.

At step 758, the teacher model generates a refinement output based on the input of the task output and the feedback. As shown in line 7-9 of algorithm 700, if the feedback f refers to “not passed.” meaning student model π_{θ}'s task output c_{θ} does not pass the unit test (u), the teacher model π_{Φ} may generate a refinement output c_{refine} based on the task input t, the student model π_{θ}'s task output c_{θ}, and feedback f.

At step 760, a training input is generated by incorporating the task input, the task output, and the feedback with a pre-defined refinement template. As shown in line 10 and 11 of algorithm 700, the task input t, student model π_{θ}'s task output c_{θ}, and feedback f may be incorporated with pre-defined refinement template T_{refine} to generate a training input t_{refine}.

At step 762, it is determined whether the teacher model's refinement output is valid as training data. In line 12, the teacher model π_{Φ}'s refinement output c_{refine} may be tested on unit test (u) to determine if it is valid as training data. If it is valid, e.g., teacher model To's refinement output c_{refine} passes the unit test (u) and has no execution error on, method 750 proceeds to step 764. If it is not valid, method 750 proceeds to step 758.

At step 764, a training pair is stored in a training dataset. The training pair includes the training input and the refinement output as the training label. If refinement output C_{refine} has no execution error, as shown in line 13-14 of algorithm 700, D_{refine} is updated by inserting and storing training input t_{refine}, and refinement output C_{refine}, and D_{code} is updated by inserting and storing task instruction t and correct solution c to task input t. As shown in line 15-17, the steps are repeated for each task instruction t in D_{STAND}. Datasets D_{refine} and D_{code} may keep being updated for until all task instructions t have been executed.

At step 766, the student model is trained using the training dataset. As shown in line 18, student model π_{θ} is trained/finetuned using PERsD-combined, e.g., D_{refine} combined with D_{code}.

### Example Results

It is assumed a dataset of code generation tasks [symbol] ={(t, u)} where each problem (or task) consists of a task instruction t and a unit test collection u. During training, a teacher model π_{ϕ} and a student model π_{ϕ} are accessed. The objective is to distill how the teacher solves code generation tasks to the student model, in the context of [symbol] . For each task (t, u), the teacher π_{ϕ}(t) is first queried with the task instruction, to get a direct generated code snippet c_{ϕ}. Then, the generated code c_{ϕ} is executed against unit test cases u and get its execution feedback f←EXEC(C_{ϕ}, u), where the EXEC function returns passed if the code passes all the unit tests, otherwise it returns an error message from the executor. By filtering out the tasks where c_{ϕ} do not pass all the unit tests (i.e., f≠passed), a new clean dataset [symbol] _{STAND}={(t, u, c)} is obtained, where each task consists of a task instruction t, a suite of unit tests u and a correct solution code c.

The student model π_{ϕ} is then finetuned on {(u, c}≈ [symbol] _{STAND}, where the input is the task instruction u and the output is the corresponding code solution c. This approach is referred to as STAND.

The STAND approach simply samples training examples (instructions and labels) from the prior distribution of the teacher model and feeds it to the student without considering the conditions of the student model. Inspired by modern education principles which advocates interactive and personalized learning experience, personalized distillation/refinement is proposed: adapting teaching materials to student's current knowledge and capacity. Three variants: PERSD-combined, PERsD-refine, and PERSD.

Iterative inference. Let [symbol] ₜₑₛₜ={(t, u)} denote the test set for inference, where each data point (t, u) consists of a task instruction t and a suite of hidden unit test cases u. It is also assumed that the task instruction contains some simple unit test cases in its doc-string (as often seen in code generation instructions), which can be extracted and formatted using rule-based heuristics to obtain a suite of seen unit test cases uₛₑₑₙ.

For single-step inference, the standard approach is used to evaluate pass@k. Specifically, for each task t, the model is queried n times with the task instruction: cⁱ₀←ϕ₀(t) for i=1 . . . n. Then, following Chen (“Evaluating Large Language Models Trained On Code,” Chen et al., 2021), pass@k is estimated from the number of attempts that passed the hidden unit test cases: EXEC(cⁱ₀,u)=passed.

Multi-step inference If the model π₀ has been trained to rectify, following the disclosed approach in PERSD-refine or PERsD-combine, and if unit tests are available during inference, per-2-step inference can be performed: for each generated attempt cⁱ₀ in 1-step, execution feedback is first obtained fⁱₛₑₑₙ+EXEC(cⁱ₀, uₛₑₑₙ). If fⁱₛₑₑₙ=passed, the original attempt is reused as the 2-step attempt. Otherwise, a refinement instruction is created: tⁱ←T_{refine} (t, cⁱ₀, fⁱₛₑₑₙ) following the approach in PERSD-refine or PERSD-combined, and query the same model with the refinement instruction for 2-step attempt: cⁱ_{0,2-step}←π₀(tⁱ). We then compute pass@k over the 2-step generations similar to 1-step inference.

The first baseline is STAND, the standard distillation approach mentioned above. To measure the effectiveness of personalized labels quantitatively, the disclosed personalized distillation/refinement is compared with Input-personalized distillation baselines as well, where only the input tasks are selected in a manner customized to the student's abilities. However, the output labels are not personalized, as they are taken from teacher's direction generation c instead of personalized refinement c_{refine}. The training data starts with [symbol] _{code} from PERSD-combined and have three variants:

INPD The student model π_{θ} is finetuned on {(t,c)}˜D_{code}, where the input is a task instruction and the output is a code solution. This variant is more customized than STAND as it filters out the tasks which the student can already solve correctly.

INPD-refine Similar to PERsD-refine, InpD-refine trains the student model to rectify its wrong attempt. The difference is in InpD-refine, the refined code is from teacher's direct solution c, instead of personalized refinement c_{refine}.

INPD-combined Similar to PERsD-combined, InpD-combined, trains the student on rectifying its answers as well as directly solving the task. The difference is that in InpD-combined, the labels for both code refinement and code generation are taken from teacher's direct solution c.

To construct the pretraining data, we adopted the data collection process in code-alpaca (“Code alpaca: An Instruction—Following Llama Model for Code Generation,” Chaudhary, 2023) and used a set of 374 seed tasks from MBPP (task-ids 601-974) as in-context prompt to query ChatGPT for novel code generation tasks. This seed-set increases the likelihood of ChatGPT generating python codes.

Through this process, a corpus of 20K code generation tasks is obtained from ChatGPT each comprising a task instruction and the corresponding generated code, which is typically a single python function. Next it is shown that each generated instance to ChatGPT again and prompted to generate 5 unique test-case inputs (i.e., input argument values) for the python function. The generated test-case input is parsed and formatted, and the generated code is executed on it obtain an output. Thus, out of 20K, for 14880 instances, 5 unit test case inputs were successfully generated and parsed, and for 10172 instances code was successfully generated and outputs were obtained on all 5 inputs. This final corpus of 10K code generation tasks, each comprising a task instruction and the corresponding generated code along with 5 unit test input and outputs forms the standard distillation dataset [symbol] _{STAND}.

To collect personalized distillation data, the student model is first asked to generate 1 output code per task, setting sampling temperature to 0.3. The student's attempt is evaluated and only the tasks with the wrong generations (i.e., the ones which failed any of the unit test-case) are kept. This is used to query ChatGPT for personalized refinements and only retain the valid refinements which passed all unit tests. The prompt to ChatGPT contains the original task instruction and code from DSTAND along with the student model's generated code and execution feedback (compiler errors or unit test failures). The instruction to ChatGPT is to generate a correct solution that rectifies the errors and is closest in semantics to the student's code. FIG. 8 shows the statistics of personalized data construction process.

The models are evaluated on two datasets: HumanEval (“Evaluating Large Language Models Trained On Code,” Chen et al., 2021), which contains 164 Python problems, and the subset MBPP (“Program Synthesis With Large Language Models,” Austin et al., 2021) sanitized set that has no overlap with our MBPP seed tasks for pretraining data collection. This corresponds to test+validation+prompt splits of MBPP-sanitized and consists of 306 Python problems. Nnucleus sampling with temperature 0.2 is used to generate 20 candidates per task for estimating pass@1, and with temperature 0.8, 100 candidates per task for estimating pass@5/10/20/50/100.

For multi-step inference, the “seen” unit test-cases are first extracted from the doc-string of the task instruction. Next, output samples are generated in the usual code-generation style forming the set of 1-step generations for each instance. Each of these candidate generations are then executed on the extracted “seen” unit test cases to obtain a refined code, thus forming the set of 2-step generations.

For all experiments with CodeGen-mono-6B backbone, effective batch size of 1024 and pre-train for 20 epochs are used. For backbone as CodeGen-mono-16B, effective batch size of 1024 and pretrain for 3 epochs are used, as the training converges much faster than CodeGen-mono-6B. For PERsD-combine with StarCoder model, effective batch size of 1024 and pretrain for 8 epochs are used, which results in similar training loss as CodeGen-mono-16B. The implementation is done using HuggingFace transformers (“In Proceedings of the 2020 Conference on Empirical Methods in Natural Language Processing: System Demonstrations,” pages 38-45, Association for Computational Linguistics, Wolf et al., 2020) and DeepSpeed Zero (“Zero: Memory Optimizations Toward Training Trillion Parameter Models,” Rajbhandari et al., 2020). All experiments are conducted on a cluster of 8 A100-40 GB GPUS.

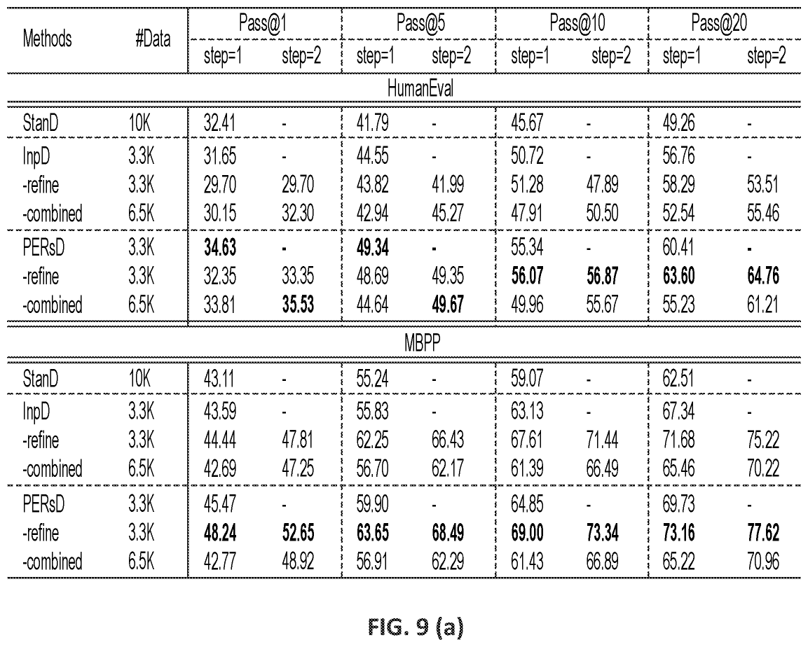

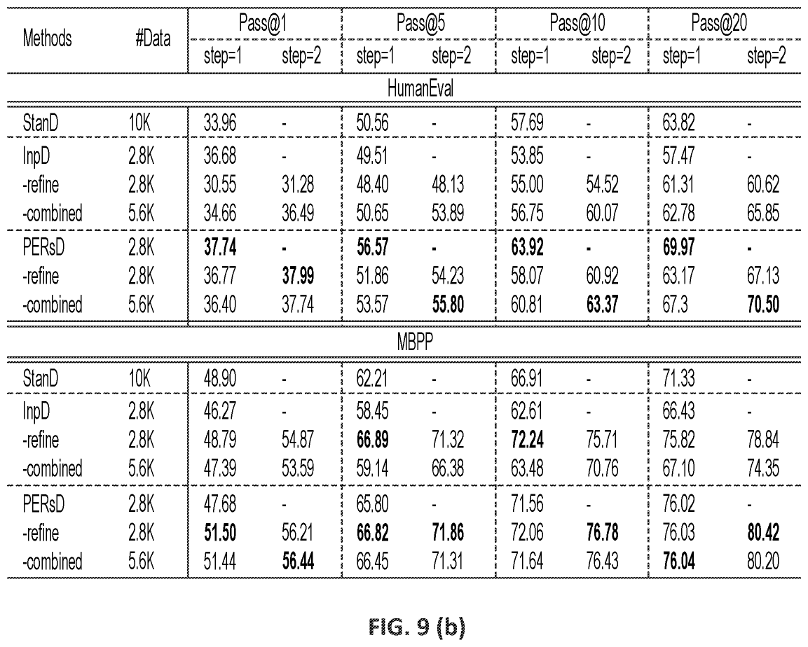

The hypothesis that personalized distillation/refinement helps student model learn more effectively is tested, by comparing PERsD models with baseline distillation methods (InpD. StanD) in FIG. 9.

Personalized labeled-data is generally better than standard data. Comparing PERsD-combine to InpD-combine, it is found that PERsD-combine outperforms InpD-combine in all settings, often with a significant margin (two backbones, two datasets, two inference steps, 4 pass@k metric). Similar observation holds true when comparing PERsD-refine to InpD-refine (except for 2/32 settings), and PERsD to InpD. Thus, it is concluded that PERsD-variants are generally significantly better than their InpD counterparts, providing strong evidence that personalized labels are more effective for the student model to learn than standard labels.

PERsD outperforms StanD with less than one-third of its data. It is observed that PERsD out-performs StanD for every pass@k on both 16B and 6B CodeGen-mono backbone across both HumanEval and MBPP, even though StanD has 10K data and PERsD has only 3.3K and 2.8K examples for CodeGen-mono-6B and 16B. The only exception is in the setting CodeGen-mono-16B, MBPP, pass@1, where StanD edges out PERsD by 1.2 points. Given that the pretraining data is constructed from seed tasks taken from MBPP, we hypothesize that StanD might enjoy an unfair advantage due to its having three times more data, making it more susceptible to data leakage. In summary, with PERsD outperforming StanD in 15 out of 16 settings while having less than a third of the data, it's evident that personalized labeled data makes the learning more efficient.

Multi-step inference consistently improves answer quality For PERsD-refine and PERsD-combine models, it is found that 2 step inference consistently improves performance on HumanEval and MBPP. This shows the models successfully learn how to rectify its solution based on execution error feedback. Note that InpD-refine yields worse accuracy with 2 step inference on HumanEval pass@10/20, strengthening the advantage of personalized labeled data over standard labeled data.

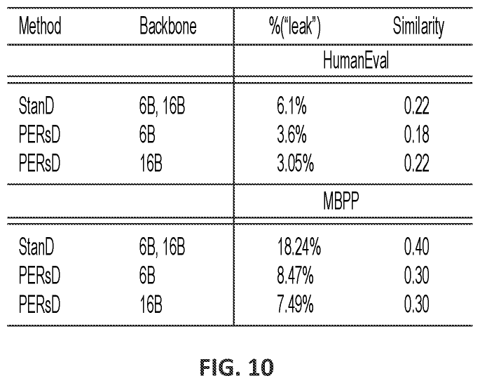

As observed in Table 4, PersD-variants enjoy higher average improvements over their InpD counterparts, on HumanEvan than on MBPP. To delve deeper, a data overlap analysis is conducted. For each test task, the most similar training task is extracted and GPT-3.5-turbo is used to score their semantic similarity, with 0 indicating no relation and 1 indicating complete semantic overlap. FIG. 10 reveals more overlap in MBPP than HumanEval, and more overlap for StanD compared to PERsD. This overlap could be why StanD surpasses PERsD in the 1/16 setting (CodeGen-mono-16B, MBPP, pass@1), as StanD has an unfair advantage of having significantly more data leakage. In addition, if the methods are tested on clean-MBPP where the leaked data points are removed, then PERsD becomes almost on-par with StanD in this specific setting while having larger margin over StanD on the rest 15/16 settings (from 4.8 points average margin to 5.9 points, more details at Appendix E). Altogether, this overlap analysis, coupled with results from cleaned MBPP, further underscores the advantages of personalized distillation/refinement.

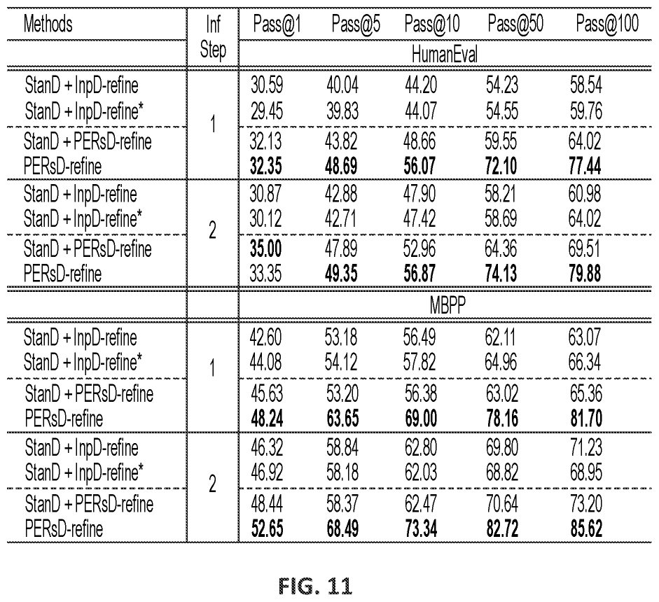

FIG. 11 shows the ablation study on mixing standard distillation data to PERsD-refine and InpD-refine: while mixing standard data to InpD-refine improves its 1-step performance on MBPP and roughly maintains its performance on other settings, mixing StanD data to PERsD-refine significantly deteriorate its performance (except pass@1 inf-step=2 on HumanEval). It is conjectured that as StanD has much larger data volume than PERsD-refine, it overwhelms the student training on standard distillation. However, combining with a balanced input-personalized data can be beneficial, as it is observed from the good performance of PERsD-combined in FIG. 9 on CodeGen-mono-16B.

In this paper, personalized distillation/refinement is introduced as a method for collecting customized labeled data that adapts to the capacity of student models, resulting in more effective learning. The advantages of personalized distillation/refinement over standard distillation in the field of code generation have been demonstrated. The personalized distillation/refinement can achieve superior performance on both the HumanEval and MBPP datasets. Through comprehensive ablation studies, it is confirmed that personalized distillation/refinement leads to higher data quality, benefits from multi-round distillation, and enables models to leverage execution feedback for self-rectification.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A system for training a neural network model using a teacher-student framework, the system comprising:
a communication interface configured to communicate with a teacher model;
a memory storing a student model and a plurality of processor-executable instructions; and
a processor executing the processor-executable instructions to perform operations comprising:
generating, by the student model, a first task output in response to a task input;
obtaining, from an evaluation environment, a feedback relating to an accuracy of the first task output;
obtaining a refinement output generated by the teacher model based on an input of the first task output and the feedback; and
training the student model based on a training input of the first task output and the feedback and a training label of the refinement output.

2. The system of claim 1, wherein the teacher model is hosted at an external server accessible via an application programming interface (API).

3. The system of claim 1, wherein the task output comprises a natural language description of a target task, and the first task output comprises a programming language segment that executes the target task.

4. The system of claim 3, wherein the evaluation environment comprises an execution of the programming language segment, and the feedback comprises an error message.

5. The system of claim 1, wherein the feedback is received upon a user review.

6. The system of claim 1, wherein the teacher model is a pretrained language model, and wherein the refinement output is generated by the teacher model based on an input prompt instructing the teacher model to generate a second task output that revises the first task output based on the feedback.

7. The system of claim 1, wherein the operation of training the student model based on a training input of the first task output and the feedback and a training label of the refinement output comprises:
generating a training input by incorporating the task input, a first task output, and the feedback with a pre-defined refinement template;
generating by the student model a student training output based on the training input; and
training the student model based on a loss objective comparing the refinement output and the student training output.

8. A method of for training a neural network model using a teacher-student framework, the method comprising:
generating, by a student model, a first task output in response to a task input;
obtaining, from an evaluation environment, a feedback relating to an accuracy of the first task output;
obtaining a refinement output generated by a teacher model based on an input of the first task output and the feedback; and
training the student model based on a training input of the first task output and the feedback and a training label of the refinement output.

9. The method of claim 8, wherein the teacher model is hosted at an external server accessible via an application programming interface (API).

10. The method of claim 8, wherein the task output includes a natural language description of a target task, and the first task output includes a programming language segment that executes the target task.

11. The method of claim 10, wherein the evaluation environment includes an execution of the programming language segment, and the feedback comprises an error message.

12. The method of claim 8, wherein the feedback is received upon a user review.

13. The method of claim 8, wherein the teacher model is a pretrained language model, and wherein the refinement output is generated by the teacher model based on an input prompt instructing the teacher model to generate a second task output that revises the first task output based on the feedback.

14. The method of claim 8, wherein the training of the student model based on a training input of the first task output and the feedback and a training label of the refinement output includes:
generating a training input by incorporating the task input, a first task output, and the feedback with a pre-defined refinement template;
generating by the student model a student training output based on the training input; and
training the student model based on a loss objective comparing the refinement output and the student training output.

15. A non-transitory machine-readable medium comprising a plurality of machine-executable instructions which, when executed by one or more processors, are adapted to cause the one or more processors to perform operations comprising:
generating, by a student model, a first task output in response to a task input;
obtaining, from an evaluation environment, a feedback relating to an accuracy of the first task output;
obtaining a refinement output generated by a teacher model based on an input of the first task output and the feedback; and
training the student model based on a training input of the first task output and the feedback and a training label of the refinement output.

16. The non-transitory machine-readable medium of claim 15, wherein the teacher model is hosted at an external server accessible via an application programming interface (API).

17. The non-transitory machine-readable medium of claim 15, wherein the task output includes a natural language description of a target task, and the first task output includes a programming language segment that executes the target task.

18. The non-transitory machine-readable medium of claim 17, wherein the evaluation environment includes an execution of the programming language segment, and the feedback comprises an error message.

19. The non-transitory machine-readable medium of claim 15, wherein the teacher model is a pretrained language model, and wherein the refinement output is generated by the teacher model based on an input prompt instructing the teacher model to generate a second task output that revises the first task output based on the feedback.

20. The non-transitory machine-readable medium of claim 15, wherein the training of the student model based on a training input of the first task output and the feedback and a training label of the refinement output includes:
generating a training input by incorporating the task input, a first task output, and the feedback with a pre-defined refinement template;
generating by the student model a student training output based on the training input; and
training the student model based on a loss objective comparing the refinement output and the student training output.
